(19) United States
(12) Patent Application Publication
(10) Pub. No.: US 2022/0270163 A1
(43) Pub. Date: Aug. 25, 2022

(54) Mobile Application with Dynamically Changing UX/ UI for Connected Devices

(71) Applicant: Dilshan Thilina Modaragamage, Ontario (CA)

(72) Inventor: Dilshan Thilina Modaragamage, Ontario (CA)

(21) Appl. No.: 17/676,114

(22) Filed: Feb. 18, 2022

Related U.S. Application Data
(60) Provisional application No. 63/151,639, filed on Feb. 20, 2021.

(51) Int. Cl. G06Q 30/06; G06F 1/16; H04L 67/306

(52) U.S. Cl. CPC G06Q 30/0641; G06F 1/163; H04L 67/306

(57) ABSTRACT

This invention relates generally to mobile computing devices such as personal digital assistants (PDAs), cellular phones, pagers, and the like, and more specifically, a system and method to automatically optimize and enhance user interface and user experience based on a signal received from a device embedded to wearable devices. An improved system, method and computer-readable instructions for dynamic user interface including computer program products, for dynamic user interface customization. A set of functions for a user interface is stored, each function comprising a function that can be added to the user interface. A first-set of data is transmitted to a user device that causes the user interface to be displayed on the user device. User's interface is based on indicative data received from the primary device. A second-set of data is transmitted to the user device that causes the user interface to dynamically change as per user's preference.

### CROSS-REFERENCE TO RELATED APPLICATIONS

For purposes of the USPTO extra-statutory requirements, the present application constitutes a nonprovisional patent application of U.S. provisional patent application Ser. No. 63/151,639, entitled “MOBILE APPLICATION WITH DYNAMICALLY CHANGING UX/UI FOR CONNECTED DEVICES”, naming DILSHAN MODARAGAMAGE as inventor, filed Feb. 20, 2021.

### FIELD OF THE INVENTION

This invention relates generally to mobile computing devices such as personal digital assistants (PDAs), cellular phones, pagers, and the like, and more specifically, a system and method to automatically optimize and enhance user interface and user experience based on a signal received from a device embedded to wearable devices.

### BACKGROUND OF THE INVENTION

In recent years, the adoption of touch-sensitive surfaces as input methods for computers and other electronic computing devices has increased. Touchpads and touch-screen displays are two examples of touch-sensitive surfaces. The usage of such surfaces to alter user interface objects on a display is common.

Example manipulations include adjusting the position and/or size of one or more user interface objects or activating buttons or opening files/applications represented by user interface objects, as well as associating metadata with one or more user interface objects or otherwise manipulating user interfaces. Example user interface objects include digital images, video, text, icons, control elements such as buttons and other graphics. A user will, in some circumstances, need to perform such manipulations on user interface objects in a file management program (e.g., Finder from Apple Inc. of Cupertino, Calif.), an image management application (e.g., Photos from Apple Inc. of Cupertino, Calif.), a digital content (e.g., videos and music) management application (e.g., iTunes from Apple Inc. of Cupertino, Calif.), a drawing application, a presentation application (e.g., Keynote from Apple Inc. of Cupertino, Calif.), a word processing application (e.g., Pages from Apple Inc. of Cupertino, Calif.), or a spreadsheet application (e.g., Numbers from Apple Inc. of Cupertino, Calif.).

Mobile applications for connected devices allow the user to send and receive data to an external device including but not limited to smart watches, fitness trackers, wearable devices, watches, hybrid watches, smart glass. These connected devices also have user interfaces (UI) to allow the user to interact with the device and application. The user interface may include but not limited to graphical elements such as logos, text, pictures, animation and other graphical elements known in the art which can be selected by the user via the mobile phones touch sensor and display screen. These elements also contribute to what is known in the art as “User Experience” where by the mobile application and provide the user an experience visually and, sometimes combined audio, by the applications manipulation of these graphical and audible elements.

Haptic feedback, typically in combination with visual feedback, is often used in an attempt to make manipulation of user interface objects more efficient and intuitive for a user. But conventional methods of providing haptic feedback are not as helpful as they could be when the smart devices which are linked with main device.

By looking at prior art in similar field there are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease-of-use ability of these assemblies is also questionable. Thus, none of the current methods provide a convenient and reliable method to provide technique for better external device management.

Therefore, it would be advantageous to design an improved method of application which dynamically changes the user interface and user experience based on the signal of the mobile phone is receiving from an external device including but not limited to smart watches, fitness trackers, wearable devices, watches, mechanical watches, analogue watches, detachable watchbands, watches, smart inserts, smart clothing, smart jewelry, smart watchbands, smartwatch buckles, hybrid watches, smart AR glasses, smart VR glasses and so on.

These and many other problems have been long identified. Different solutions to the problems have been tried. However there exists no comprehensive solution to all the above problems. None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY OF THE INVENTION

Given the shortcomings of the prior art, the following summary is presented to aid understanding of some of the novel aspects of the present invention and is not meant to be a complete explanation. Taking the complete specification, claims, drawings, and abstract as a whole allows for a comprehensive understanding of the invention's various aspects.

The primary desirable object of the present invention is to provide a novel and improved form of system readable instructions allowing to create user experience and interface changes-based om the signals received.

Another object of the present invention is to provide a method and interfaces optionally complement or replace conventional methods for manipulating user interfaces of connected devices. Such methods and interfaces reduce the cognitive burden on a user and produce a more efficient human-machine interface.

It is a more particular object of the present invention to provide, a method which is performed at an electronic device with a display, a touch-sensitive surface, and one or more tactile output generators.

A further objective of the present invention to provide an application which dynamically changes the User interface and user experience based on the signal the mobile phone is receiving from an external device.

Yet another objective of the present invention to provide an assembly which has a unique feature of the enhancing user's shopping experience. The application with built in shop displays the products which are of interest to user.

A further objective of the present invention to provide a smart assembly which provide ease of use and convenience to everyone and is comes in both physical and digital form.

Yet another objective of the present invention to provide a new and improved form of mobile application which determines the type and brand of the device connected via Bluetooth, wifi, NFC, and dynamically changes the application's user experience and user Interface to a predetermined set of UX/UI.

Thus, it is the objective of the present invention to provide a new and improved method of mobile application with dynamically changing user interface for connected devices. Other aspects, advantages and novel features of the present invention will become apparent from the detailed description of the invention when considered in conjunction with the accompanying drawings.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 schematically visualizes the workflow of customized dynamic user interface.

FIG. 2 provides a flow diagram that provides steps involved in computer-implemented method of customized dynamic user interface.

FIG. 3 provides a schematic visualization of an example embodiment of the prevent invention providing details of how a default user interface changes to a customized user interface based on the type and/or brand of the wearable device.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

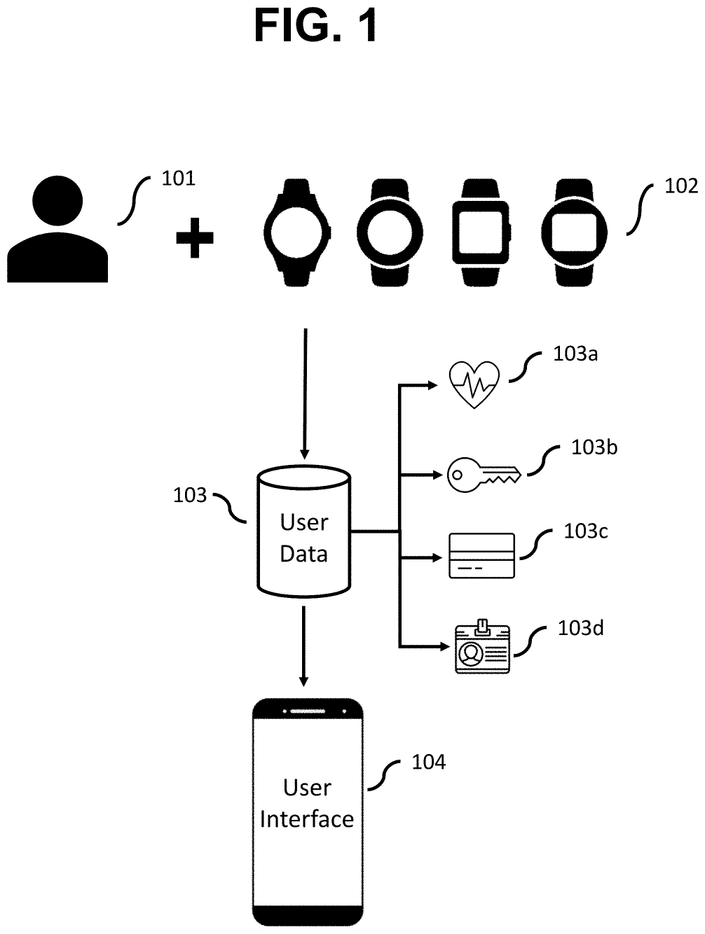

Turning to the figures, FIG. 1 schematically shows the different aspects of the invention, and specifically the FIG. 1 includes a user 101, a collection of wearable devices 102, user data 103 that includes but not limited to user's fitness and health data 103a, user's digital key data 103b, user's credit card data 103c, user's access cards data 103d etc., and a user device 104 that includes a automatically optimizable dynamic user interface or user experience.

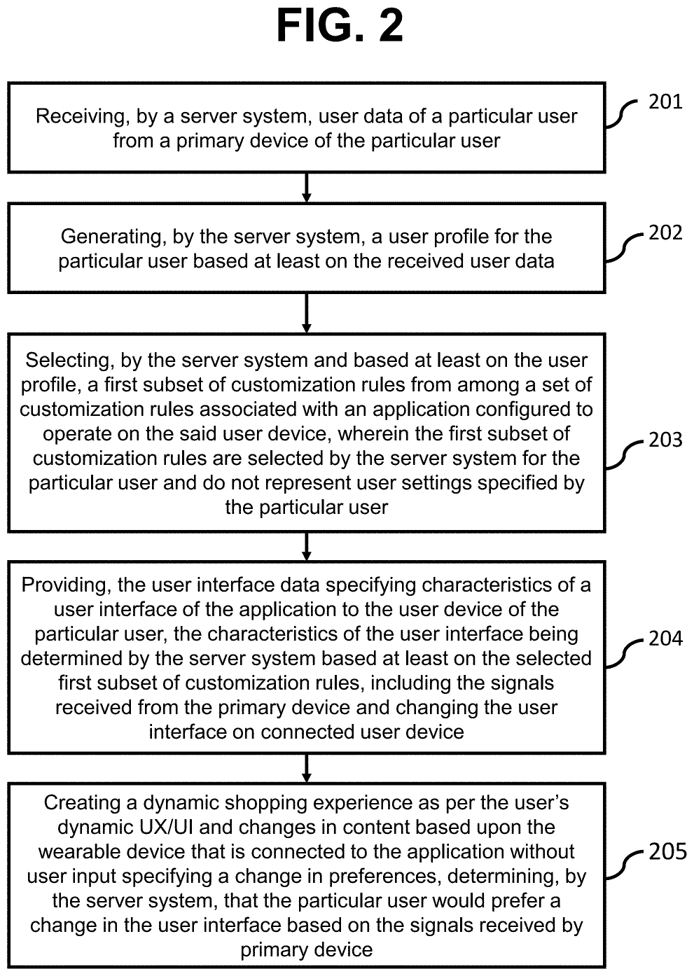

Now referring to FIG. 2, an embodiment of the present invention provides a computer-implemented method of optimized dynamic user interface, wherein the method comprising steps of: (a) receiving, user data of a particular user from a primary device of the particular user 201; (b) generating, by the server system, a user profile for the particular user based at least on the received user data 202; (c) selecting, by the server system and based at least on the user profile, a first subset of customization rules from among a set of customization rules associated with an application configured to operate on the said user device, wherein the first subset of customization rules are selected by the server system for the particular user and do not represent user settings specified by the particular user 203; (d) providing, the user interface data specifying characteristics of a user interface of the application to the user device of the particular user, the characteristics of the user interface being determined by the server system based at least on the selected first subset of customization rules, including the signals received from the primary device and changing the user interface on connected user device 204; and (e) creating a dynamic shopping experience as per the user's dynamic UX/UI and changes in content based upon the wearable device that is connected to the application without user input specifying a change in preferences, determining, by the server system, that the particular user would prefer a change in the user interface based on the signals received by primary device 205.

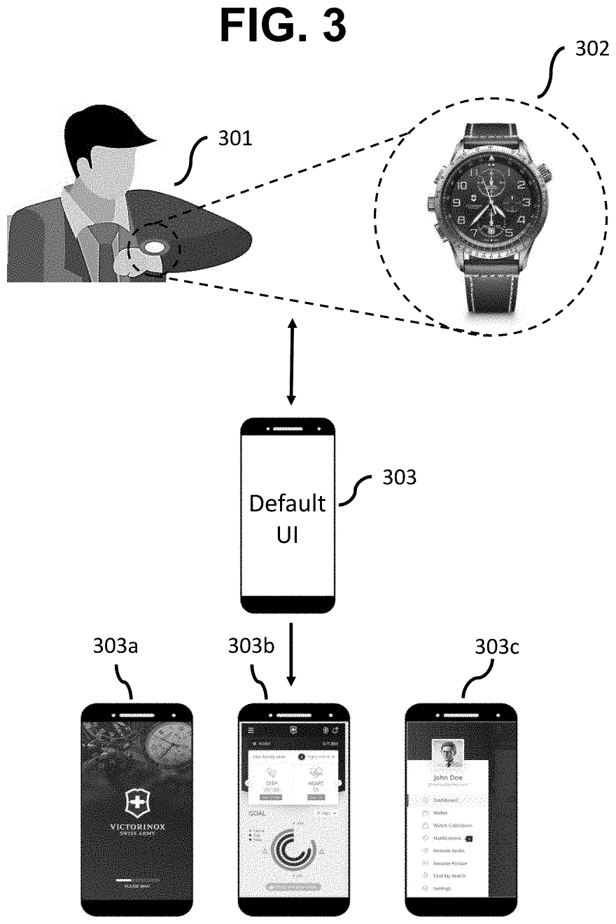

Similarly, FIG. 3 provides a flow visualization of an example embodiment of the present invention that provides a user wearing a watch 301, a watch 302, a user device visualizing default user interface 303, and an automatically updated customized user interface based on the type and/or brand of the watch further visualizing loading mode 303a, dashboard 303b and menu drawer 303c of the automatically updated customized user interface.

User interfaces can sometimes be customized using a set of user selections that indicate user preferences. For instance, user interfaces can be modified to create user experience interactions, variable color schemes, fonts, graphical illustrations, content, and layout of information, sounds, shock, vibration, touch and tactile sensory reaction. However, many customization techniques require a user to actively select from a set of static, predetermined options. In addition, many techniques are unable to make use of extrinsic data that reflect user behavior and thus cannot adapt to a user's changing needs and circumstances.

In one embodiment of the present invention, to provide users an enhanced experience, an application for a user device that can automatically optimize its interface and content for a user and dynamically adjust the interface and content in response to the user's needs—either passively or actively. In particular, the interface of the application can be adjusted without the user selecting or requesting changes to the interface. The reconfiguration of a user interface may be based on various factors. For example, user interactions with the application and survey responses can be used to determine appropriate interface characteristics. In addition, appropriate changes for the user interface can be inferred from the user's interaction with other applications on the user device, conditions sensed by the user device, and other user behaviors independent of the application. By automatically and gradually changing a user interface and experience, both based on explicit user input and inferred information about the user, the application can greatly enhance its usefulness to the user.

In the same embodiment of the present invention, the adjustments made to the user interface of an application can be performed automatically and without any explicit user action to change the user interface. A variety of information can be used to adjust the user interface, including sensor data, user behavior data, and other information that allow the user's preferences and needs to be inferred without the user specifying them. With this information, the application can iteratively make gradual, unexpected changes that adapt the user interface to the user's personalized needs. In addition, the user can enroll in one or more health programs which support different aspects of the user's wellbeing (e.g., general fitness, diabetes care, smoking cessation, meditation, etc.) Each of these programs may include customization rules that can be selected, when appropriate, to customize the user interface so that the user interface provides information in an appropriate manner for each particular user.

In the same embodiment of the present invention, the present invention is directed to provide an improved method of mobile application for connected devices allowing the user to send and receive data to an external connected device including but not limited to smart watch, fitness trackers, wearable devices, watches, hybrid watches, smart glass and similar devices.

The system as per its preferred embodiments provides inter smart/connected device which have user interfaces (UI) to allow the user to interact with the device and application. The user interface may include but not limited to graphical and audible elements such as logos, text, pictures, animation, videos, and sounds which can be selected by the user by using the said user device, wherein the said graphical elements contribute to users experience and provides the user an experience visually and combined audio, by the manipulation of graphical and audible elements using the said dynamic user interface.

The proposed system enables user device to automatically optimizes the said dynamic user interface and user experience based on the signal the user device is receiving from the said primary device, wherein the said signal can include but not limited to WAN, LAN, Internet, Bluetooth, NFC, RFID, LTE, GSM, and 5G. Specifically, the UI changes dynamically based on device connected and that determination can be made by mobile device or server system. The UI assets (text, icons, images, animations, etc) the software uses to change the UI/UX for user can be held on sever or mobile device or can be taken from the device the user is wearing. The user does not need to be enrolled in any service for this to happen. Even if the user has never downloaded the application before and is doing so for the first time, the application will read the information (via BLE, NFC, WIFI, LTE, RFID, etc.) on the device that the user is wearing and dynamically change the UI/UX to match the brand of device that the user is wearing and provide branding shopping experience. In addition, for deciding the type of UX/UI to use, the system only uses the mac address, UUID, UDID etc to initially determine if it is a device that can connect to the said application. Then once the connection is established, more information will be read from the users device like serial number, device ID, model number, mac address, chip ID, brand name, device name, etc. and then using the same information, the system decides the type of UX/UI to display.

For example, a Bluetooth signal can send unique identifiers such as the UUID, UDID, mac address, and other identifiers known in the art. The device will broadcast many types of information (date, time, serial numbers of chips, device id's, brand names, etc) and identifiers that the mobile phone and application can receive and read. Based on the information received by the application that is running on the mobile phone from the device broadcasting, the application can connect to the device and make determinations on user interface and user experience. The application shows a pre-determined user experience and user interface based on information/data received by the device broadcasting the data which may have a unique identifier to signal to the application to use a specific set of user interface and user experience for that particular device.

For example, if device 1 with a mac address of 011.001.df.10 is connected to the mobile application, the mobile application may select user interface and user experience #3 by querying to a library of UX/UI located either on the mobile phone, internet data base, API data base, backend server and other known in the art then dynamically change the app's UX/UI to the one that has been pre-determined for that particular device's unique identifier such as mac address. If device #1 signal is lost and app searches and is able to connect to device #2 with mac address of 021.001.df.10, the user interface is selected from a library of pre-designed and pre-customized user interfaces located on but not limited to the user device, internet data base, API data base, and backend server and other known in the art then dynamically change the app's UX/UI to the one that has been pre-determined for that particular device's unique identifier such as mac address.

The mobile application as per its further embodiments also facilitates and enhances user's shopping experiences. The proposed system uses this process to give the user a shopping experience. The application has a built-in shop/store where products can be purchased by the user. This store is also a part of the dynamic UX/UI and changes its content based upon the device that is connected to the application.

For example, based on the unique identifier such as a mac address of the device that is broadcasting and connecting to the application, the application determines this device is known and is a watch manufactured by brand A. Once this is identified, the shop/store built into the application will change all of the products that it is displaying for the user to purchase to show only watches and accessories of the brand of the watch connected to the device, which is brand A. If a watch from brand B connects to the mobile app, then it will suitably change the products and accessories being displayed to the user to that of Brand B. This is a dynamic shopping experience based on what the user is wearing at the time the device is connected to the mobile application.

While a specific embodiment has been shown and described, many variations are possible. With time, additional features may be employed. The particular shape or configuration of the platform or the interior configuration may be changed to suit the system or equipment with which it is used. Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The abstract of the disclosure is provided to allow the reader to quickly ascertain the nature of the technical disclosure. It is submitted with the understanding that it will not be used to interpret or limit the scope or meaning of the claims. In addition, in the foregoing detailed description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the detailed description, with each claim standing on its own as a separately claimed subject matter.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is described above with reference to a preferred embodiment. However, those skilled in the art will recognize that changes and modifications may be made in the described embodiment without departing from the nature and scope of the present invention. To the extent that such modifications and variations do not depart from the spirit of the invention, they are intended to be included within the scope thereof.

### ABBREVIATIONS

5th Generation Mobile Network (5G)
Global System for Mobile Communications (GSM)
Local Area Network (LAN)
Long-Term Evolution (LTE)
Near-Field Communication (NFC)
Radio Frequency Identification (RFID)
Unique Device Identifier (UDID)
Universally Unique Identifier (UUID)
User Experience (UX)
User Interface (UI)
Wide Area Network (WAN)

Having fully and clearly described the invention so as to enable one having skill in the art to understand and practice the same, the invention claimed is:

1. A computer-implemented method of optimized dynamic user interface, wherein the method comprising steps of:
a) receiving, by a server system, user data of a particular user from a primary device of the particular user;
b) generating, by the server system, a user profile for the particular user based at least on the received user data;
c) selecting, by the server system and based at least on the user profile, a first subset of customization rules from among a set of customization rules associated with an application configured to operate on the said user device, wherein the first subset of customization rules are selected by the server system for the particular user and do not represent user settings specified by the particular user;
d) providing, the user interface data specifying characteristics of a user interface of the application to the user device of the particular user, the characteristics of the user interface being determined by the server system based at least on the selected first subset of customization rules, including the signals received from the primary device and changing the user interface on connected user device; and
e) creating a dynamic shopping experience as per the user's dynamic UX/UI and changes in content based upon the wearable device that is connected to the application without user input specifying a change in preferences, determining, by the server system, that the particular user would prefer a change in the user interface based on the signals received by primary device.

2. A method according to claim 1, wherein the said user interface enables users to save, review and utilize data related to fitness, health, access card, credit card and digital key.

3. A method according to claim 1, wherein the said user interface of user device dynamically and automatically optimizes by itself without the user selecting or requesting changes to the interface, wherein the said automatic optimization is based on variety of data that includes sensor data, user behavior data, and specific information that allow the user's preferences and needs to be inferred without the user specifying them.

4. A method according to claim 1, wherein the said user interface is selected from a library of pre-designed and pre-customized user interfaces located on but not limited to the user device, internet data base, API data base, and backend server.

5. A method according to claim 1, wherein the said program facilitates user's shopping experiences by provided a built-in shop/store in the said user interface where products can be purchased by the user, wherein the said built-in shop/store optimizes its content based on the wearable device to which the primary device is connected.

6. A method according to claim 1, wherein the said user data of a particular user from a wearable device of the particular user is not always necessary for the determine the type of user interface and the type of user interface can be automatically determined based on the wearable device data.

7. A system for optimized dynamic user interface, the system comprising:
a primary device, wherein the said primary device is embedded to a wearable device in a way that the said primary device captures user data and wearable device data;
a user device;
at least one dynamic user interface;
a storage device; and
a processor connected to the storage device, wherein the storage device storing a program for controlling the processor; and the processor operative with the program to:
receive, by a server system, user data of a particular user from a primary device of the particular user;
generate, by the server system, a user profile for the particular user based at least on the received user data;
select, by the server system and based at least on the user profile, a first subset of customization rules from among a set of customization rules associated with an application configured to operate on the said user device, wherein the first subset of customization rules are selected by the server system for the particular user and do not represent user settings specified by the particular user;
provide, the user interface data specifying characteristics of a user interface of the application to the user device of the particular user, the characteristics of the user interface being determined by the server system based at least on the selected first subset of customization rules, including the signals received from the primary device and changing the user interface on connected user device; and
create a dynamic shopping experience as per the user's dynamic UX/UI and changes in content based upon the wearable device that is connected to the application without user input specifying a change in preferences, determining, by the server system, that the particular user would prefer a change in the user interface based on the signals received by primary device.

8. A system according to claim 7, wherein the said user device is capable of processing the said dynamic user interface.

9. A system according to claim 7, wherein the said wearable device includes but not limited to smart watch, fitness trackers, wearable devices, watches, hybrid watches, smart glass.

10. A system according to claim 7, wherein the said wearable device data transferred from the primary device to the user device is related to wearable device type and identification.

11. A system according to claim 7, wherein the said dynamic user interface enables users to save, review and utilize data related to fitness, health, access card, credit card and digital key.

12. A system according to claim 7, wherein the said user device automatically optimizes its interface and content for a user and dynamically adjust the interface and content in response to the user's needs and activities.

13. A system according to claim 7, wherein the said user interface of user device dynamically and automatically optimizes by itself without the user selecting or requesting changes to the interface, wherein the said automatic optimization is based on variety of data that includes sensor data, user behavior data, and specific information that allow the user's preferences and needs to be inferred without the user specifying them.

14. A system according to claim 7, wherein the said dynamic user interface enables users to enroll in health programs which support different aspects of the user's wellbeing, wherein the said health programs include customization rules that can be selected, when appropriate, to customize the user interface so that the user interface provides information in an appropriate manner for each user.

15. A system according to claim 7, wherein the said dynamic user interface include but not limited to graphical and audible elements such as logos, text, pictures, animation and sounds which can be selected by the user by using the said user device, wherein the said graphical elements contribute to users experience and provides the user an experience visually and combined audio, by the manipulation of graphical and audible elements using the said dynamic user interface.

16. A system according to claim 7, wherein the said user device automatically optimizes the said dynamic user interface and user experience based on the signal the user device is receiving from the said primary device, wherein the said signal can include but not limited to WAN, LAN, Internet, Bluetooth, NFC, RFID, LTE, GSM, and 5G.

17. A system according to claim 7, wherein the said user interface is selected from a library of pre-designed and pre-customized user interfaces located on but not limited to the user device, internet data base, API data base, and backend server.

18. A system according to claim 7, wherein the said program facilitates user's shopping experiences by provided a built-in shop/store in the said user interface where products can be purchased by the user, wherein the said built-in shop/store optimizes its content based on the wearable device to which the primary device is connected.

19. A system according to claim 7, wherein the said user data of a particular user from a wearable device of the particular user is not always necessary for the determine the type of user interface and the type of user interface can be automatically determined based on the wearable device data.

20. A system according to claim 7, wherein the said user interface enables users to save, review and utilize data related to fitness, health, access card, credit card and digital key.
